(19) United States
(12) Patent Application Publication
(10) Pub. No.: US 2004/0246997 A1
(43) Pub. Date: Dec. 9, 2004

(54) Asynchronous receiver of the UART-type with two operating modes

(75) Inventors: Ludovic Ruat, Saint Savourin (FR); Paul Kinowski, Aix-en-Provence (FR); Alexander Czajor, Bouc Bel Air (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics SA, Montrouge (FR)

(21) Appl. No.: 10/824,932

(22) Filed: Apr. 15, 2004

Related U.S. Application Data
(63) Continuation of application No. PCT/FR02/03480, filed on Oct. 11, 2002.

(30) Foreign Application Priority Data
Oct. 15, 2001 (FR) 0113270

(51) Int. Cl. H04L 5/16

(52) U.S. Cl. 370/509

(57) ABSTRACT

A asynchronous frame receiver includes an input for receiving asynchronous frames. The asynchronous frames include standard characters, and a header that has a data bit length greater than a data bit length of the standard characters. A break character detection unit detects the break character. A standard character processing unit for detecting the standard characters is activated by the break character detection unit based upon the break character being detected.

### RELATED APPLICATION

The present application is a continuation of International Application No. PCT/FR02/03480 filed on Oct. 11, 2002, the entire disclosure of which is incorporated herein by reference.

### FIELD OF THE INVENTION

The present invention relates to devices that transmit asynchronous data, generally called universal asynchronous receiver transceivers (UARTs). The present invention more particularly relates to a receiver that receives asynchronous frames beginning with a break character followed by a plurality of standard characters.

### BACKGROUND OF THE INVENTION

Asynchronous data are generally transmitted using asynchronous frames comprising one or more standard characters. Such standard characters generally comprise 10 bits, among which there are 8 data bits preceded by a start bit and followed with a stop bit. Contrary to synchronous data transmissions, the receiver does not receive the clock signal of the emitter. The respective clocks of the transmitter and the receiver must have, in relation to one another, a deviation that does not exceed a certain value so that the data are correctly transmitted.

To increase the transfer possibilities of asynchronous data between devices having clock circuits which are less precise and likely to have high drifts in relation to one another, there has been newly developed data transmission protocols allowing a receiver to synchronize its clock signal with the clock signal of a transmitter by the transmitter sending a synchronization character. Such protocols are consequently less demanding relating to the deviation of the clock signal of the receiver in relation to the clock signal of the emitter. In the following, local clock signal means the clock signal of the receiver, and reference clock signal means the clock signal transmitted by a synchronization character.

By way of example, FIG. 1 shows an asynchronous frame according to the protocol LIN (Local Interconnect Network). The LIN frame begins with a break character BRK comprising a series of bits at 0 and ending with a last bit equal to 1. (extra bit). This series of bits at 0 has a minimum length of 13 bits and the character BRK is deemed to be received when 11 bits at zero are detected. This allows a deviation on the order of 15% to be tolerated between the local clock signal and the reference clock signal. The frame further comprises standard characters of 10 bits, including a synchronization character SYNC followed with one or more data characters CH1, CH2 . . . CHN. In multi-point links between a master device and slave devices, the first data character CH1 is used as an identification field for designating the addressee of a frame.

It thus appears that the receiver must be able to process characters of variable length. It is here a question of technical constraint which imposes on one hand the processing of characters of 13 bits, and on the other hand, the taking into account of the length of the different characters. This processing is performed by software but has a non-negligible computation time for the calculator in charge of the operation. The calculator is generally the CPU (central processing unit) of a microprocessor or a microcontroller.

Furthermore, depending on the context in which it is used, a frame receiver may receive conventional frames which comprise standard data characters only, for example in the case of a conventional asynchronous link, or to receive frames comprising a break character in a header, possibly followed with a synchronization character and an identification character, etc.

### SUMMARY OF THE INVENTION

In view of the foregoing background, an object of the present invention is to simplify the processing of asynchronous frames is a receiver, in particular, a multiprotocol receiver that simplifies the task of a microprocessor's central processing unit.

This and other objects, advantages and features in accordance with the present invention are provided by an asynchronous frame receiver receiving frames comprising standard characters, which may comprise in a header a break character with a length greater than the one of a standard character. The receiver may also comprise a break character detection unit and a standard character processing unit. The standard character processing unit is distinct from the break character detection unit and is activated by the break character detection unit when active.

The receiver may comprise means for selecting a first operating mode in which the break character detection unit is deactivated, or a second operating mode in which the break character detection unit is active and controls the standard character processing unit.

The break character detection unit may detect a break character formed of bits having all the same value. The break character detection unit may also detect a synchronization character.

The receiver may comprise a self-synchronization circuit for synchronizing a local clock signal of the receiver with a reference clock signal present in a synchronization character. The self-synchronization circuit may be activated by the break character detection unit. The break character detection unit may be a state machine. The standard character processing unit may also be a state machine. The means for selecting a first or a second operating mode may comprise a register in which a mode bit is stored.

The present invention also relates to an integrated circuit comprising a receiver according to the invention. The present invention also relates to a micro-controller comprising a receiver according to the invention.

The present invention also relates to a method for receiving asynchronous frames comprising standard characters and comprising, in a header, a break character with a length greater than a length of a standard character. The method may comprise detecting a character followed with a step of standard character processing, in which the break character detection and the standard character processing steps are performed with distinct means by a break character detection unit and a standard character processing unit. The processing unit may be activated by the detection unit when this one is active.

The break character detection unit may detect a break character formed of bits having all the same value. The break character detection step may be performed by a state machine. The standard character processing may also be performed by a state machine. The method may comprise identifying a synchronization character received after the break character. The method may comprise synchronizing a local clock signal using a reference clock signal present in the synchronization character, with the recovery step following the identification step. The method may comprise selecting a first operating mode in which the break character detection unit is deactivated, or a second operating mode in which the break character detection unit is active and controls the standard character processing unit.

### BRIEF DESCRIPTION OF THE DRAWINGS

These objects, characteristics and advantages as well as others of the present invention will be described with more details in the following description of an exemplary embodiment of an asynchronous frame receiver according to the invention, done in a non-limiting way, in conjunction with the accompanying drawings in which:

FIG. 1 shows an asynchronous frame based upon an LIN protocol according to the prior art;

FIG. 2 shows a detection unit of a break character according to the present invention;

FIG. 3 shows a processing unit of standard characters according to the present invention;

FIG. 4 shows a synchronization character according to the present invention;

FIG. 5 shows a device according to the present invention;

FIGS. 6A to 6E show electrical or logic signals appearing in the circuit of FIG. 5; and

FIG. 7 schematically shows a micro-controller comprising a circuit according to the present invention.

### DETAILED DESCRIPTION OF THE PREFERRED EMBODIMENTS

As mentioned above, a break character BRK comprises a series of N bits at 0, for example 13 bits at 0 in the protocol LIN, to which it will be referred in the following by way of a non-limiting example. To take into account a frequency difference between this signal and the local clock signal of the receiver, the detection of this character is performed (according to the protocol LIN) by identifying a series of 11 bits at 0. This number of 11 bits is defined by convention to tolerate a deviation of ±15% between the local clock signal and the reference clock signal.

An asynchronous frame receiver UART1 according to the invention comprises a detection unit for detecting the break character BRK, which is for example in the form of a first state machine SM1.

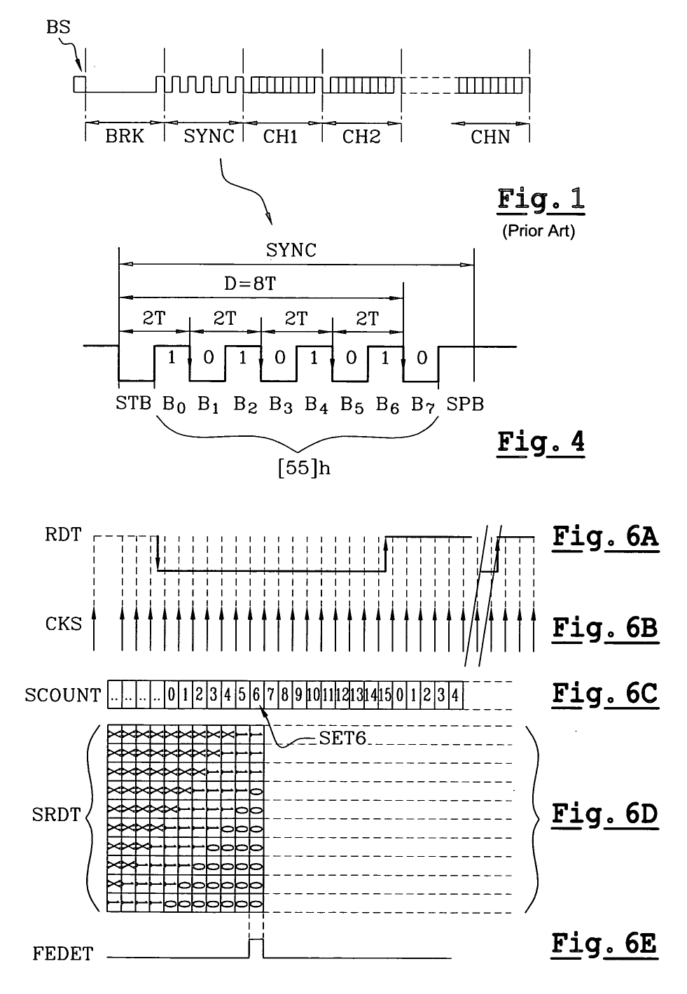

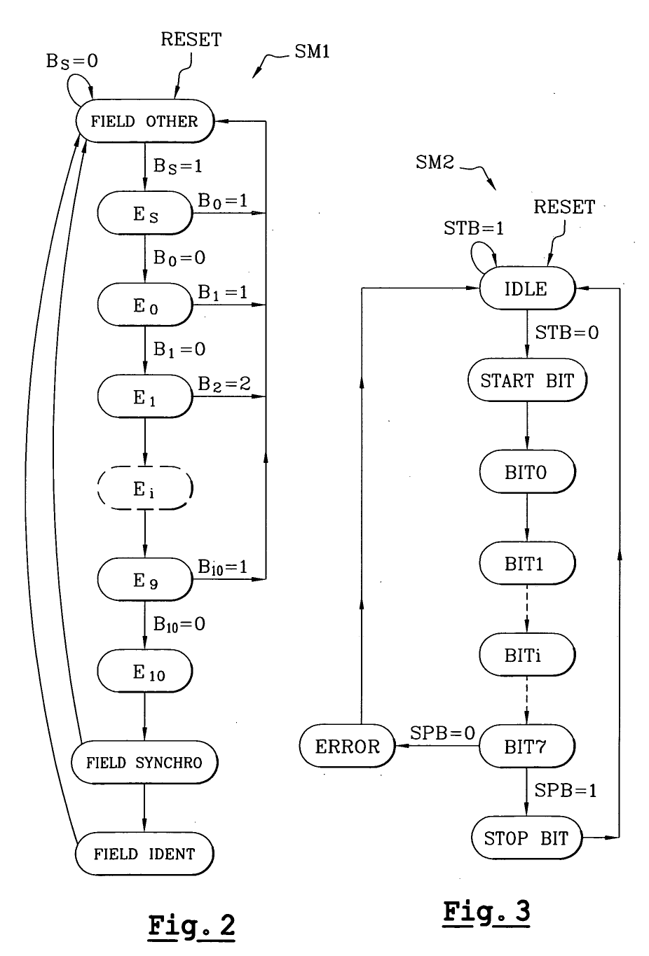

An example embodiment of such a state machine SM1 is represented in FIG. 2. The state machine SM1 comprises an IDLE state FIELD OTHER which is rendered active after application of a reset signal RESET to the state machine. The reception of a bit BS at 1 (bit BS preceding a character BRK, FIG. 1) triggers the passage from the state FIELD OTHER to an intermediate state ES. The reception of the following bit B0, if it is equal to 0, respectively to 1, causes the passage to an intermediate state E0, or respectively, the return to the IDLE state. In the state E0, the reception of the second bit B1 following the bit BS, if it is equal to 0, respectively 1, triggers the passage to an intermediate state E1, or respectively, the return to the IDLE state.

By way of generalization, the reception, by the state machine being in an intermediate state Ei, of the (i+1)^{th} bit following bit BS causes the passage to a state Ei+1 or the return to the IDLE state depending on whether the received bit is equal to 0 or 1.

When index i is equal to 9, the reception of the eleventh bit B10 following bit BS, depending on whether it is equal to 0 or 1, triggers the passage to a state E10 or the return to the IDLE state.

It should be noted that the break character BRK can be detected in other ways, for example by a shift register of 11 bits, all the bits of which are subject to a logic AND operation.

When the break character BRK is detected, the following characters of the frame are all standard characters formed of 10 bits. According to the invention, these standard characters are processed by a dedicated processing unit, different from the characters BRK detection unit.

This processing unit comprises, for example, a second state machine SM2 as shown in FIG. 3. State machine SM2 comprises IDLE (wait), START BIT (reception of a start bit STB at 0), BIT0 (reception of a first data bit), BIT1 (reception of a second data bit), . . . BITi (reception of a data bit of rank i), . . . BIT7 (reception of an eighth data bit), STOP BIT (reception of a stop bit SPB at 1 after reception of the eighth data bit), and ERROR (reception of a bit at 0 after reception of the eighth data bit) states. The IDLE state is activated after application of a control RESET to the state machine. The access to the START BIT state requires the reception of a bit at 0, otherwise the state machine remains in the IDLE state. The states BIT0, BIT1 . . . BITi . . . BIT7 follow themselves without condition. In the case of a reception error of the stop bit after the eighth data bit B7, the state machine passes to the state ERROR and returns to the IDLE state.

It thus appears that a receiver UART1 according to the invention comprises a first state machine SM1 for identifying a character BRK specific to some protocols, in particular the protocol LIN, and a second state machine SM2, sometimes called in the prior art UART STANDARD STATE MACHINE.

In these conditions, an advantage of the present invention is to provide two operating modes in a circuit UART1 according to the invention. The first operating mode is a conventional operating mode in which only the second state machine SM2 is active. The second operating mode is an operating mode dedicated to protocols of the LIN type, providing a break character BRK in the frame beginning. In the second operating mode, both state machines are used and the first state machine SM1 activates the second state machine SM2, and after that a character BRK is detected.

The state machine SM1, briefly described above, may furthermore be improved to ensure the complete detection of the frame header. The standard characters are still processed by state machine SM2. Thus, in an embodiment dedicated to protocol LIN, the state machine SM1 may comprise, in addition to the above described states, a FIELD SYNCHRO state and a FIELD IDENT state. The FIELD SYNCHRO state is reached after detection of a character BRK, i.e., after passage to the state E10, and covers the period of reception of the synchronization character SYNC provided by the protocol LIN. When the state machine SM1 is in the FIELD SYNCHRO state, it deactivates the state machine SM2 because the received field is not considered as a standard character and some operations must be performed, in particular the synchronization of a local clock, as will be discussed below. According to an advantageous aspect of the invention, the state machine SM1, when in the FIELD SYNCHRO state, further activates a local clock self-synchronization circuit.

The FIELD IDENT state is reached after reception of a valid character SYNC, and corresponds to the reception of the first data character CH1 used in the protocol LIN as an identification field of the addressee of the frame. After the FIELD IDENT state, the state machine SM1 returns to the state FIELD OTHER.

The analysis of the synchronization character SYNC will now be discussed in greater detail. The synchronization character SYNC represented with more details in FIG. 4 is equal to [55]h in hexadecimal notation, that is 10101010 in binary notation. This character is preceded by a start bit STB at 0 and followed with a stop bit SPB at 1. There are in total 5 falling edges for synchronizing a local clock signal to the reference clock signal present in the character SYNC. The duration between the 5 falling edges is equal to 8 times the period T of the reference clock signal. The measure of this duration allows the reference period T to be determined and the period of the local clock signal to be matched with it.

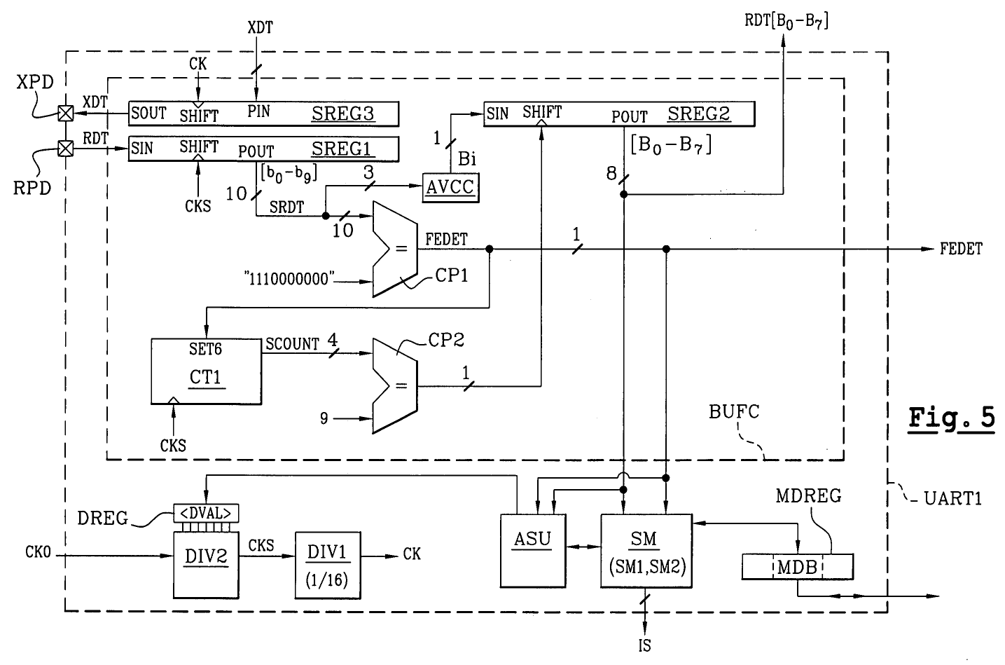

FIG. 5 shows in a schematic way the architecture of a circuit UART1 according to the invention, allowing the synchronization of a local clock signal CK with the clock signal carried by a synchronization character SYNC. The local clock signal CK is delivered by a divider DIV1, here a divider by 16, receiving a sampling signal CKS as an input. Signal CKS is itself delivered by a programmable divider DIV2 receiving a primary clock signal CK0 as an input. The ratio between the frequency of signal CK0 and the frequency of signal CKS is determined by a value DVAL loaded in a register DREG of the programmable divider.

The circuit UART1 also comprises a buffer circuit BUFC and a state machine SM comprising the two state machines SM1, SM2 described above, which identifies the break BRK and synchronization SYNC characters, and delivers information signals IS to the outside environment. The outside environment is, for example, a microcontroller architecture (not represented) in which the circuit UART1 is arranged. The signals IS indicate, for example, that a synchronization character SYNC is being received, that a received data is available for reading in the circuit BUFC, etc.

Buffer circuit BUFC comprises two reception registers SREG1, SREG2, an emission register SREG3, a 4 bit counter CT1 (counter by 16), two logic comparators CP1, CP2 and a circuit AVCC. Register SREG1 is a shift register of 10 bits, the input SHIFT of which is clocked by signal CKS. It receives data RDT on a serial input SIN connected to a data reception terminal RPD, and delivers sampled data SRDT (bits b0 to b9) on a parallel output POUT. The data SRDT are applied to the input of circuit AVCC, the output of which delivers a bit Bi which is sent to a serial input SIN of register SREG2. Each bit Bi delivered by the circuit AVCC is conventionally equal to the majority value of the samples of rank 7, 8 and 9 (bits b7 to b9) present in the register SREG1.

The data SRDT are also applied to an input of comparator CP1, the other input of which receives a reference number 1110000000, forming a detection criteria of falling edges. The comparator CP1 delivers a signal FEDET which is communicated to the outside environment and is also applied to a resetting to 6 input (input “SET 6”) of counter CT1, which is clocked by signal CKS. The counter CT1 delivers a sample counting signal SCOUNT which is applied to an input of the comparator CP2, the other input of which receives, in a binary form, a reference number equal to 9 in base 10. The output of comparator CP2 drivers the shifting input SHIFT of register SREG2. Lastly, register SREG3 is a shift register clocked by the local clock signal CK, receiving data XDT on a parallel input PIN and delivering serial data XDT on an output SOUT connected to a terminal XPD.

The detection by circuit UART1 of the falling edges of a synchronization character SYNC is illustrated in FIGS. 6A to 6E, which respectively show the data RDT, the sampling signal CKS, the signal SCOUNT, the data SRDT sampled by register SREG1, and the signal FEDET. The passage to 1 of signal FEDET indicates that a falling edge is detected and occurs when the data SRDT are equal to 1110000000. The falling edges is detected after reception of seven samples equal to 0, counter CT1 is reset to the value 6 (that is the seventh counting cycle from 0) at the time of the passage to 1 of the signal FEDET.

After reception of the synchronization character SYNC, the data present in the characters CH1, CH2 . . . are received bit by bit. A data bit Bi delivered by circuit AVCC (majority value of the samples b7 to b9) is loaded into register SREG2 every 16 cycles of signal CKS, that is every cycle of the local clock signal CK. The loading of a bit Bi is performed at the tenth counting cycle of counter CT1 when the output of comparator CP2 passes to 1. The received data RDT are stored in register SREG2 by groups of 8 bits B0-B7 and are read by a parallel output POUT of this register.

The synchronization character SYNC represented in FIG. 4 may allow an external computation unit, for example the central processing unit of a microcontroller, to determine the value DVAL to be placed in divider DIV2 to obtain a small deviation of the local clock signal CK. This value is such that the period Ts of the sampling signal CKS must be equal to Ts=D/(8*16), where D is the time measured between the five falling edges of the synchronization character SYNC, that is eight periods T of the reference clock.

However, in an advantageous embodiment of the circuit UART1 according to the invention, the state machine SM is associated with a wired logic self synchronization unit ASU, which analyses the character SYNC and determines the value DVAL to be loaded into the register DREG so that it is no longer necessary to perform this calculation using software that is part of a central processing unit. The unit ASU is activated by the state machine SM1 when this one passes to the state FIELD SYNCHRO, as mentioned above.

Furthermore, according to an optional but advantageous aspect of the present invention, the circuit UART1 further comprises a register MDREG in which a mode bit MDB accessible for reading and for writing from the outside environment is stored. When the mode bit has a first value, the circuit UART1 operates as a conventional UART circuit, and state machine SM1 is deactivated, as well as consequently the self synchronization unit ASU. When the mode bit has a second value, the two state machines SM1, SM2 are operational and the circuit UART1 can process complex frames such as for example LIN frames.

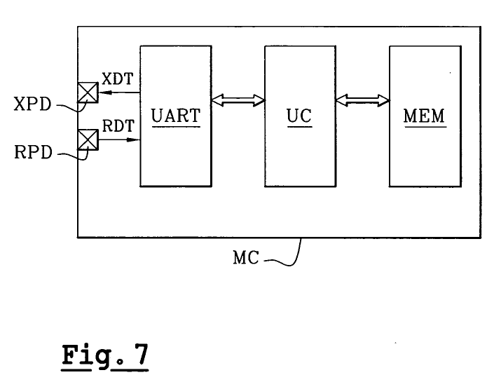

By way of an example of implementing the present invention, FIG. 7 schematically shows a microcontroller MC comprising, on a same silicon chip, a central processing unit UC, a program memory MEM, and a circuit UART1 according to the invention. The circuit UART1 is connected to input/output pads RPD/XPD of the integrated circuit. The central processing unit UC uses the circuit UART1 for the transmission and the reception of asynchronous data XDT, RDT via the pads XPD, RPD.

It will be clearly apparent to those skilled in the art that the present invention is likely to have various alternatives and embodiments. In particular, any described step may be replaced with an equivalent step within the scope and spirit of the present invention.

That which is claimed is:

1. An asynchronous frame receiver comprising:
an input for receiving asynchronous frames comprising standard characters, and a header comprising a break character with a data bit length greater than a data bit length of the standard characters;
a break character detection unit for detecting the break character; and
a standard character processing unit for detecting the standard characters, said standard character processing unit being activated by said break character detection unit based upon the break character being detected.

2. An asynchronous frame receiver according to claim 1, further comprising a selection circuit for selecting a first operating mode in which said break character detection unit is deactivated, or a second operating mode in which said break character detection unit is active and controls said standard character processing unit.

3. An asynchronous frame receiver according to claim 1, wherein said break character detection unit detects a break character formed of bits having a same value.

4. An asynchronous frame receiver according claim 1, wherein the asynchronous frames comprise a synchronization character, and wherein said break character detection unit detects the synchronization character.

5. An asynchronous frame receiver according to claim 4, further comprising a self-synchronization circuit for synchronizing a local clock signal of the receiver with a reference clock signal in the synchronization character.

6. An asynchronous frame receiver according to claim 5, wherein said self-synchronization circuit is activated by said break character detection unit.

7. An asynchronous frame receiver according to claim 1, wherein said break character detection unit comprises a first state machine, and wherein said standard character processing unit comprises a second state machine.

8. An asynchronous frame receiver according to claim 2, wherein said selection circuit comprises a register for storing a mode bit.

9. An asynchronous frame receiver according to claim 1, further comprising a substrate, and wherein said break character detection unit and said standard character processing unit are on said substrate so that the receiver comprises an integrated circuit.

10. A microcontroller comprising:
a universal asynchronous receiver transceiver (UART) comprising
an input for receiving asynchronous frames comprising standard characters, and a header comprising a break character with a data bit length greater than a data bit length of the standard characters,
a break character detection unit for detecting the break character, and
a standard character processing unit for detecting the standard characters, said standard character processing unit being activated by said break character detection unit based upon the break character being detected; and
a processor connected to said UART.

11. A microcontroller according to claim 10, wherein said UART further comprises a selection circuit for selecting a first operating mode in which said break character detection unit is deactivated, or a second operating mode in which said break character detection unit is active and controls said standard character processing unit.

12. A microcontroller according to claim 10, wherein said break character detection unit detects a break character formed of bits having a same value.

13. A microcontroller according claim 10, wherein the asynchronous frames comprise a synchronization character, and wherein said break character detection unit detects the synchronization character.

14. A microcontroller according to claim 13, wherein said UART further comprises a self-synchronization circuit for synchronizing a local clock signal of said UART receiver with a reference clock signal in the synchronization character.

15. A microcontroller according to claim 14, wherein said self-synchronization circuit is activated by said break character detection unit.

16. A microcontroller according to claim 10, wherein said break character detection unit comprises a first state machine, and wherein said standard character processing unit comprises a second state machine.

17. A microcontroller according to claim 11, wherein said selection circuit comprises a register for storing a mode bit.

18. A method for processing asynchronous frames in an asynchronous frame receiver, the method comprising:
receiving as input by the asynchronous frame receiver the asynchronous frames comprising standard characters, and a header comprising a break character with a data bit length greater than a data bit length of the standard characters;
detecting the break character in the asynchronous frames using a break character detection unit; and
activating a standard character processing unit based upon the break character detection unit detecting the break character.

19. A method according to claim 18, wherein the asynchronous frame receiver comprises a selection circuit for selecting a first operating mode in which the break character detection unit is deactivated, or a second operating mode in which the break character detection unit is active and controls the standard character processing unit.

20. A method according to claim 18, wherein the break character detection unit detects a break character formed of bits having a same value.

21. A method according claim 18, wherein the asynchronous frames comprise a synchronization character, and wherein the break character detection unit detects the synchronization character.

22. A method according to claim 21, wherein the asynchronous frame receiver further comprises a self-synchronization circuit for synchronizing a local clock signal of the asynchronous frame receiver with a reference clock signal in the synchronization character.

23. A method according to claim 22, wherein the self-synchronization circuit is activated by the break character detection unit.

24. A method according to claim 18, wherein the break character detection unit comprises a first state machine, and wherein the standard character processing unit comprises a second state machine.
